(19) United States
(12) Patent Application Publication
(10) Pub. No.: US 2023/0000278 A1
(43) Pub. Date: Jan. 5, 2023

(54) Steam stove

(71) Applicant: MING-CHIA TAI, TAICHUNG CITY (TW)

(72) Inventor: MING-CHIA TAI, TAICHUNG CITY (TW)

(21) Appl. No.: 17/367,084

(22) Filed: Jul. 2, 2021

(51) Int. Cl. A47J 27/05; F24C 13/00

(52) U.S. Cl. CPC A47J 27/05; F24C 13/00; A47J 2027/043

(57) ABSTRACT

A steam stove contains: a body, a steaming module, two flowing conduits, and two heating modules. The body includes a steam room defined therein and being opened or closed, a water tank formed on a bottom of the steam room and accommodating the steaming module, two vertical partitions vertically arranged on two sides of the steam room of the body so as to produce the two flowing conduits, and a bottom and a top of each of the two flowing conduits are in communication with the water tank and the steam room. Each of the two heating modules is fixed in each of the two flowing conduits and is not shielded by the water tank, and a horizontal partition is defined among two bottoms of the two vertical partitions and the body so as to shield the water tank.

### FIELD OF THE INVENTION

The present invention relates to a steam stove which is capable of enhancing a temperature to heat and sterilize foods effectively.

### BACKGROUND OF THE INVENTION

A conventional steam stove mainly includes a body, a heating structure, and a water supply device. The body is provided with multiple steaming meshes for placing food, and the heating structure contains a heat tank. The bottom of the heat tank is formed into a flat plate on the bottom of the body to accommodate waters, and a gas stove or electric heating tube is used to directly heat the bottom of the heating tank. The waters are boiled to produce water vapors, and the waters are fed into the heating tank via a water inlet pipe. However, a steaming structure is arranged on the bottom of the body through the heating structure, and the electric heating tube is covered by the waters to generate water vapors to heat the foods on the meshes. However, the electric heating tube and the body are covered with waters. Therefore, the water vapors can only reach 100° C., which is the boiling point of the liquid to cause poor heating effect.

The present invention has arisen to mitigate and/or obviate the afore-described disadvantages.

### SUMMARY OF THE INVENTION

The primary aspect of the present invention is to provide a steam stove which is capable of enhancing a temperature to heat and sterilize effectively.

Another aspect of the present invention is to provide a steam stove which contains the steaming module and the two heating modules so that the steaming module heats the waters from the water tank to produce the water vapors, and the two heating modules heat the water vapors of the steam room successively to enhance heating and sterilizing effect greatly.

To obtain the above mentioned aspects, a steam stove provided by the present invention contains: a body, a steaming module, two flowing conduits, and two heating modules.

The body includes a steam room defined therein and being opened or closed, a water tank formed on a bottom of the steam room and accommodating the steaming module, two vertical partitions vertically arranged on two sides of the steam room of the body so as to produce the two flowing conduits, and a bottom and a top of each of the two flowing conduits are in communication with the water tank and the steam room.

Each of the two heating modules is fixed in each of the two flowing conduits and is not shielded by the water tank, and a horizontal partition is defined among two bottoms of the two vertical partitions and the body so as to shield the water tank.

### BRIEF DESCRIPTION OF THE DRAWINGS

FIG. 1 is a perspective view showing the exploded components of a steam stove according to a preferred embodiment of the present invention,

FIG. 2 is a perspective view showing the assembly of the steam stove according to the preferred embodiment of the present invention.

FIG. 3 is a cross sectional view showing the operation of the steam stove according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention,

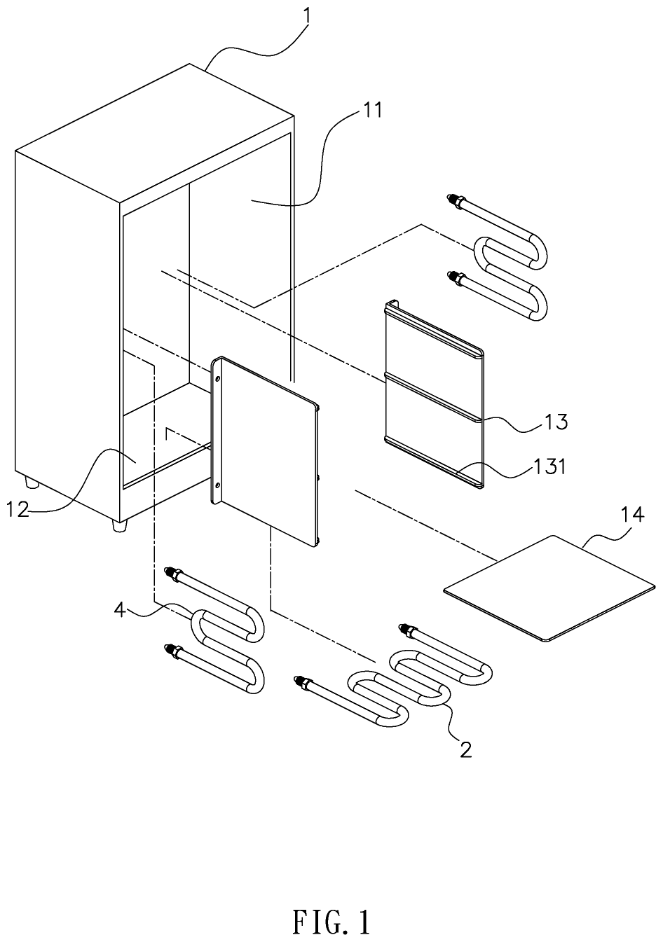

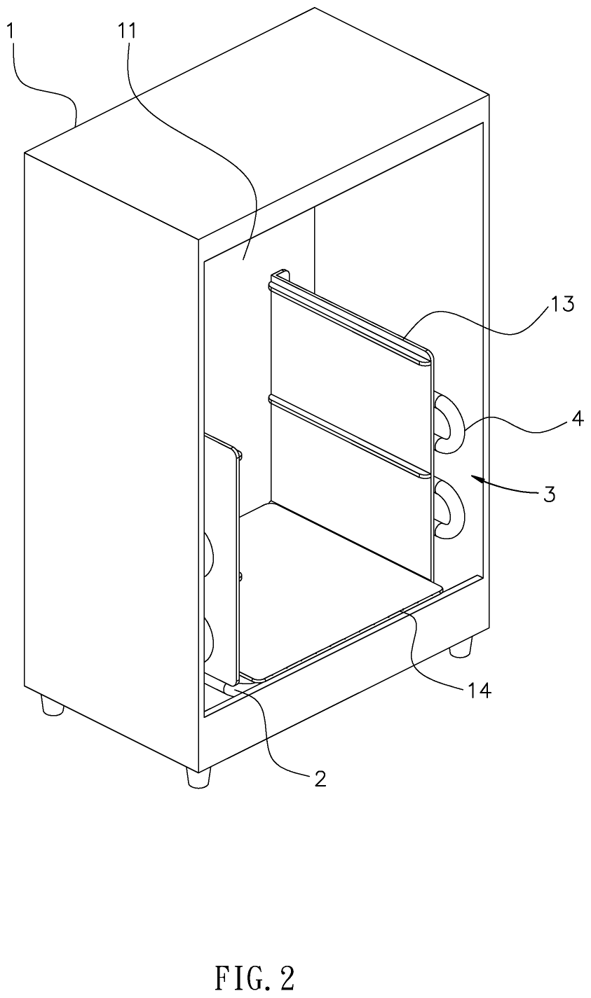

With reference to FIGS. 1-3, a steam stove according to a preferred embodiment of the present invention is capable of enhancing a temperature to heat and sterilize foods effectively. The steam stove comprises a body I, a steaming module 2, two flowing conduits 3, and two heating modules 4. To simplify drawings of the present invention, a door, a temperature control system, and a fluid feeder of the steam stove are omitted in the drawings.

The steaming module 2 and the heating module 4 are a heating tube, the body 1 includes a steam room 11 defined therein and being opened or closed, a water tank 12 formed on a bottom of the steam room 11 and accommodating the steaming module 2, two vertical partitions 13 vertically arranged on two sides of the steam room 11 of the body 1 so as to produce the two flowing conduits 3, and a bottom and a top of each of the two flowing conduits 3 are in communication with the water tank 12 and the steam room 11. Each of the two heating modules 4 is fixed in each of the two flowing conduits 3 and is not shielded by the water tank 12. wherein a horizontal partition 14 is defined among two bottoms of the two vertical partitions 13 and the body 1 so as to shield the water tank 12.

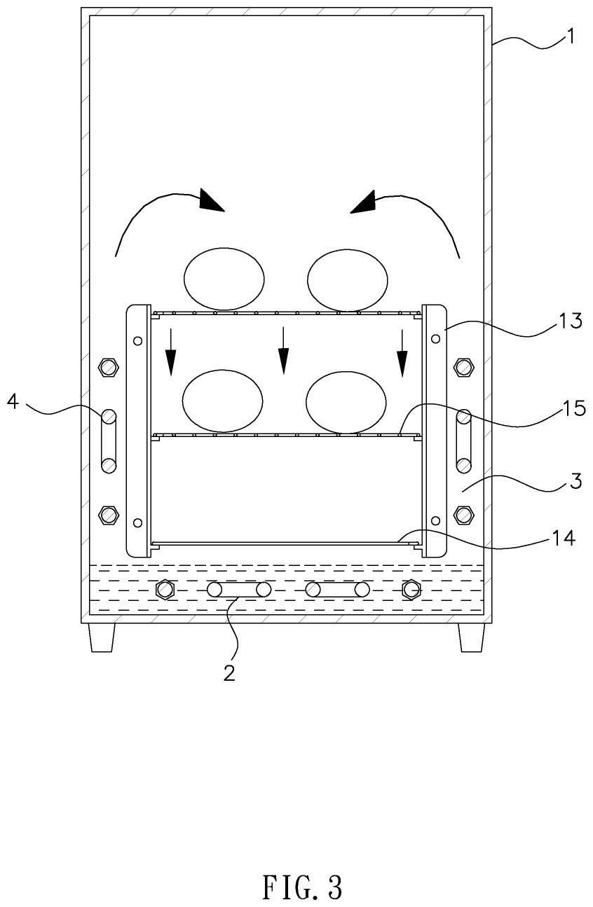

In operation, the steaming module 2 heats waters from the water tank 12 so that the waters reach a boiling point to produce water vapors, and the water vapors are stopped by the horizontal partition 14 and the two vertical partitions 13 to flowing into the steam room 11 upward along the two flowing conduits 3, as shown in FIG. 3, and the two heating modules 4 heat the water vapors continuously, then the steaming module 2 heats the water vapors, thus enhancing a temperature of the water vapors in the steam room 11 effectively.

The two vertical partitions 13 and the horizontal partition 14 are made of conductive materials, such as aluminum or copper, thus avoiding interfere of a heating effect of the two heating modules 4. Each of the two vertical partitions 13 has multiple support ribs 131 extending inward so as to support a mesh 15 between two horizontally opposite support ribs 131 of the multiple support ribs 13, such that the two vertical partitions 13 separate the steam room 11 to avoid careless contact of the foods with the two heating modules 4.

Thereby, the steam stove contains the steaming module and the two heating modules so that the steaming module heats the waters from the water tank to produce the water vapors, and the two heating modules heat the water vapors of the steam room successively to enhance heating and sterilizing effect greatly. For example, the water vapors of the steam room are heated up to 120° C. to 180° C.

While various embodiments in accordance with the present invention have been shown and described, it is clear to those skilled in the art that further embodiments may be made without departing from the scope of the present invention.

What is claimed is:

1. A steam stove comprising: a body, a steaming module, two flowing conduits, and two heating modules;
wherein the body includes a steam room defined therein and being opened or closed, a water tank formed on a bottom of the steam room and accommodating the steaming module, two vertical partitions vertically arranged on two sides of the steam room of the body so as to produce the two flowing conduits, and a bottom and a top of each of the two flowing conduits are in communication with the water tank and the steam room; and
wherein each of the two heating modules is fixed in each of the two flowing conduits and is not shielded by the water tank, and a horizontal partition is defined among two bottoms of the two vertical partitions and the body so as to shield the water tank.

2. The steam stove as claimed in claim 1, wherein each of the two vertical partitions has multiple support ribs extending inward so as to support a mesh between two horizontally opposite support ribs of the multiple support ribs.
